(19) United States
(12) Patent Application Publication
(10) Pub. No.: US 2015/0189226 A1
(43) Pub. Date: Jul. 2, 2015

(54) HandHeld Video And Audio Communication Device

(71) Applicant: Matteo Gravina, Laredo, TX (US)

(72) Inventor: Matteo Gravina, Laredo, TX (US)

(21) Appl. No.: 14/145,435

(22) Filed: Dec. 31, 2013

(51) Int. Cl. H04N 7/14

(52) U.S. Cl. CPC H04N 7/141

(57) ABSTRACT

The present invention provides an open means of communication with a similar device through the internet. More specifically, the present invention provides a video and audio communications portal by interacting with similar addressing schemes. The addressing scheme utilized by the end user is the one given to the device. The addressing scheme includes the Media Control Access address or MAC address. Therefore, this device is free from fixed cellular service providers. A user using the device of the present invention does not need to sign contract with any cellular service provider in either United States of America or the world.

### BACKGROUND OF THE INVENTION

1. Field of the Invention

The present invention generally relates to video and audio communication systems. Specifically, the present invention relates to wireless internet teleconference between similar devices.

2. Description of Related Art

Communications through electronic means has always carried either audio or video, and in some instances both means of communicating wirelessly has evolved gradually mainly through audio. Audio has been the main form of communications around the world. With the advent of microelectronics and further advancements has lead people to communicate easier and faster.

As technology advances the means of communications using both audio and video have also advanced. In addition to the hardware, compression means which allow firmware to work with the hardware and evolve topologies have also advanced. This has led to several types of communications, such as point-to-point, which is referred to as videophone. The precursors to this technology use old analogue telephone lines which limit the quality of the communications link. With the advance of asymmetrical digital subscriber line, integrated services digital network, and broadband, this topology has evolved with the advance of the internet.

Another form of video and audio communications is telepresence videoconferencing, which is the most advanced form of communications between multiple users. It is the use of higher end components, communications lines, and software technologies. This form of communications employs a large visual display, high-end camera, and high quality audio. This allows users to communicate person to person or multiple users to communicate with a wider audience. Large rooms with multiple cameras and high definition video permit large parties to host meetings across vast distances either across a local area or across the world. Unfortunately, telepresence requires special equipment, and assistance at both ends of the communication link for proper communications. In U.S. Pat. No. 7,154,526 (2006), the use of more than one person is required for deploying a teleconference.

Yet, another form of communications is the use of a webcam and a software program that allows video and audio communications. This process permits the user to communicate via audio and video across primarily the internet. It is the most common communications between two people across vast distances. Fort most occasions the webcam is either bought with the associated software. Most modern laptops and handheld devices already come with a webcam or video cam for use just in case the user is able to communicate with other parties that have similar abilities to communicate. Unfortunately, webcam and associated software require a computer, and therefore the expense of a computer (including a laptop) itself, and sometimes the expense of the software program are unavoidable.

Some of these software programs are readily available on the internet. These software clients permit users to interface with video, audio, and instant messaging. Such programs like Skype, Google Talk, Yahoo Messenger, among others are the norm and the default communication for the average day user. Millions of users around the world communicate with these and similar client programs. Unfortunately, these client programs come either with an associated subscription recurrent cost, or with integrated commercials. In addition, they have to associate with a certain type of operating system, and service pack. Still these technologies work only with their own client program. In addition, third party system is required as in US patent application 20120268553 A1.

The latest means of communicating comes about with the use of what is commonly known as 4G. 4G is short for fourth generation, taken out of context which is a simulation of smart handsets, communication protocols, and higher bandwidth. These amalgamations of technologies permit multiple communication devices to interface. These technologies which are primarily divided into two categories, being Mobile WiMAX, and Long Term Evolution (LTE), allow users to communicate between their different types of devices. The biggest leap forward and the greatest market for these technologies are in the area of the handset. With all available means to communicate two handset users, likely being smart phones, are able to communicate through video and audio instantaneously. Unfortunately, for cellular high bandwidth and Smartphone technology, users have to depend on 1) the Smartphone handset technology, 2) high cellular bandwidth, 3) a high bandwidth service, 4) above a certain level of usage, and 5) credit service for cellular service.

Therefore, there is a need for a handheld portable system and method that can offer audio and video communication through the internet in a cost-effective manner.

### SUMMARY OF THE INVENTION

Accordingly, it is an object of the present invention to provide an open means of communication with a similar device through the internet, more precisely a video and audio communications portal by interacting with similar addressing schemes. It will become apparent that the scheme utilize by this means is easily understood and will allow communication between users around the world.

Moreover, the present invention allows communications with current technology which was not available to past videophone or the current videophone technology. The present invention uses rather the internet as a medium and internet addressing. The addressing scheme utilized by the end user is the one given to the device. It is the Media Control Access address or MAC address. Therefore, this device does not require on demand services and is free and independent of fixed networks.

Moreover, yet another form of communications commonly known as telepresence video conferences deploys extensive equipment, software/firmware, and technical assistance to deploy a telepresence conference. Unlike this communication means, the present invention only requires the addition of another user. Once the users are detected, the present invention opens a direct communication line.

Unlike the telepresence video conference, the device is easily operated and become usable once it's powered, and the server internet address, network internet address, and the Media Control Access address of the other party's devices are entered. Meanwhile, the telepresence video conference requires a lead technician to address technical issues.

Moreover, for other hardware and software protocols and standards to work, computer, laptop, or other similar devices need to be turned on and a special program needs to be opened followed by contact request. With this invention after a contact is registered all the user needs to do is to press a button for request. Thereby, initiating an open line to communicate in a more expedient manner.

Still yet, the size of the invention screen allows for a higher resolution by not over sizing video content as oppose to having the creation of pixilation, video degradation by over sizing an incoming video information as opposed to current client programs.

Still yet, the size of the invention is small enough to permit enough bandwidth across the internet as to allow an expanded audience capability. As long as enough bandwidth is permitted in any part of the world, a user in a technological connected node can connect with a person in another part of the world having a minimal bandwidth capability.

The more important features of the invention have thus been outlined in order that the more detailed description that follows may be better understood and in order that the present contribution to the art may better be appreciated. Additional features of the invention will be described herein after and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a front view representation of the device in accordance with an embodiment of the present invention;

FIG. 2 is an angle view presentation of the device in accordance with the embodiment of the present invention;

FIG. 3 is a top view presentation of the device in accordance with the embodiment of the present invention;

FIG. 4 is a left side view presentation of the device in accordance with the embodiment of the present invention;

FIG. 5 is a right side view presentation of the device in accordance with the embodiment of the present invention;

FIG. 6 presents a diagram of how numeration significance is represented in accordance with the embodiment of the present invention;

FIG. 7 presents a diagram of MAC Addressing in accordance with the embodiment of the present invention;

FIG. 8 presents a diagram of IPv6 Addressing in accordance with the embodiment of the present invention;

FIG. 9 presents a front view presentation of the device with a MAC Address in accordance with the embodiment of the present invention;

FIG. 10 presents a front view presentation of the device with a MAC Address in accordance with the embodiment of the present invention;

FIG. 11 presents a front view presentation of the device with an IPv6 Address in accordance with the embodiment of the present invention;

FIG. 12 presents a front view presentation of the device with a MAC Address, a second MAC Address, and a IPv6 Address in accordance with the embodiment of the present invention;

FIG. 13 presents a qwerty keyboard diagram in accordance with the embodiment of the present invention;

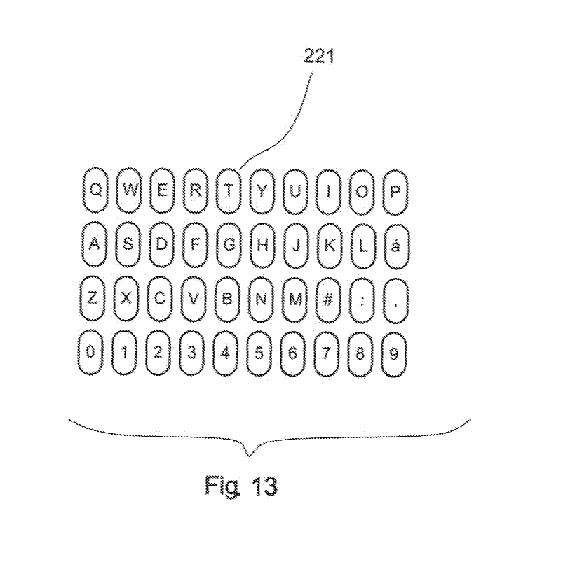

FIG. 14 is a presentation of a logical diagram of the device controller and associated interconnections in accordance with the embodiment of the present invention;

FIG. 15 presents a logical diagram of the process work in accordance with the embodiment of the present invention;

FIG. 16 presents a front view of the device with a list of contacts in accordance with the embodiment of the present invention;

FIG. 17 presents a front view of the device with a contact, a contact picture, and contact call button, in accordance with the embodiment of the present invention;

FIG. 18 presents a logical diagram of the process of operation in accordance with the embodiment of the present invention;

FIG. 19 presents a front view of the device with the history log list in accordance with the embodiment of the present invention;

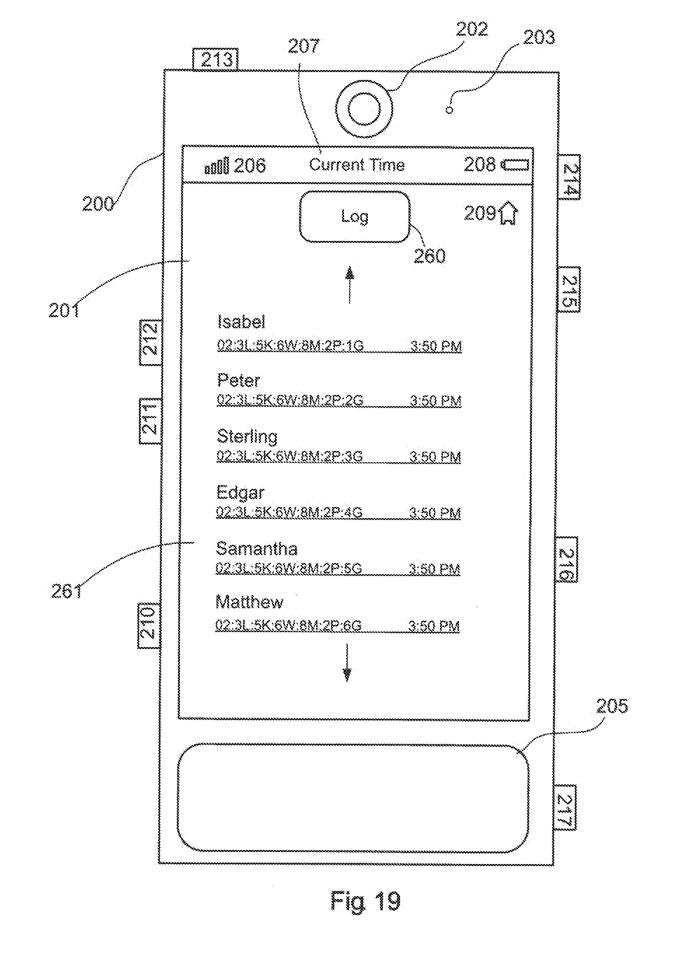

FIG. 20 presents the device transmission with a distance from its wireless connection coming from a structure in accordance with the embodiment of the present invention;

FIG. 21 presents the device and process of interconnection through the internet and retransmission intermodal with a second device in accordance with the embodiment of the present invention;

FIG. 22 presents the simultaneous wireless transmission between a router/modem and three wireless devices, device, and device in accordance with the embodiment of the present invention;

FIG. 23 presents how more than one device can communicate with another device within reach of limited wireless reach of one router/modem, and communication with another device, and a third device, whereby simulcasting is presented in accordance with the embodiment of the present invention; and

FIG. 24 presents communication links in the world wide web between distances in accordance with the embodiment of the present invention.

### DESCRIPTION OF THE PREFERRED EMBODIMENT

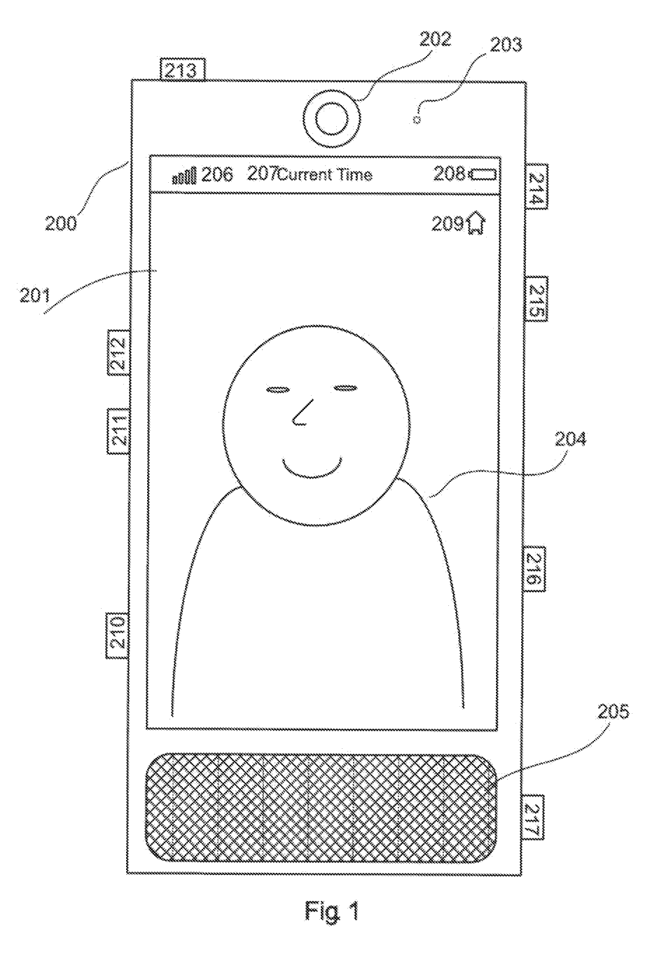

Referring to FIG. 1, there is disclosed a handheld and portable communication device 200 for live chatting/conferencing over the internet in accordance with one embodiment of the present invention.

The device 200 is a typical handheld and portable device surrounded by buttons and ports around the physical layout. FIG. 1 is a front view of the device 200 which has a screen display 201 in the center. The image of the person 204 who uses another device 244 (the contact party) will appears on the screen 201 when a communication is taking place. The device 200 has a port 210 for external memory and a contrast button 211 and a sharpness button 212 for adjusting the quality of the video display on the left side. The port on the top left of the device 200 is the audio port 213, which is for connecting external hearing devices. On the middle top facing the user is the camera 202, which is for receiving the image of the person talking in front of the device 200. On the lower right side of the camera 202 is the microphone 203 which is necessary for capturing the surrounding sound. The antenna strength signal 206, the current time 207 and the battery icon 208 are displayed at the upper area of the screen 201. At a lower section below the battery icon 208 is the home icon 209, which is used as an escape key or return key. A volume control button 214 for increasing and decreasing volume, a power button 215 for turning on and off the device 200, and a picture button 216 are located on the right side of the device 200. The picture button 216 is used to take a picture of the person who uses another device 244 by capturing the image of the contact party who appears on the screen 201. At the lower end below the picture button 216 is the power device port 217 that is for connecting the device 200 to a power source which can power the device 200. At the section below the screen is the speaker 205 for audio duplex sound.

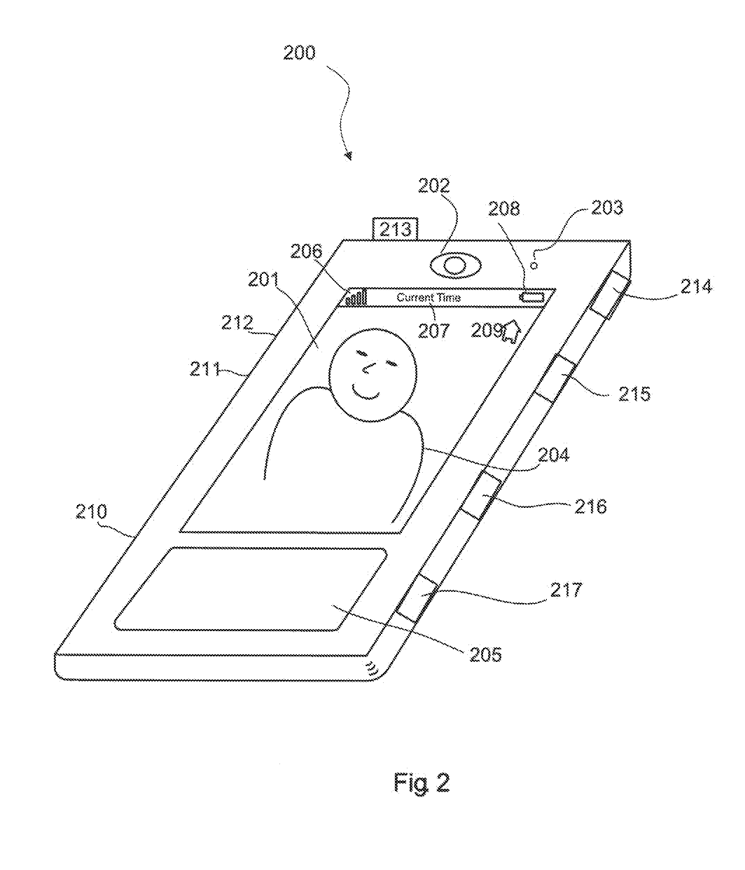

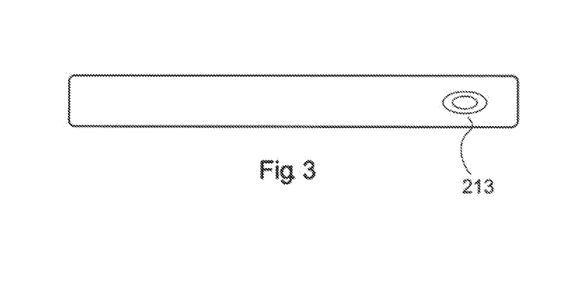

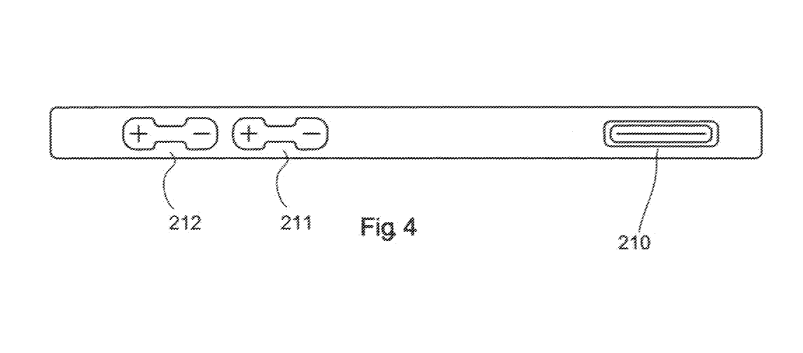

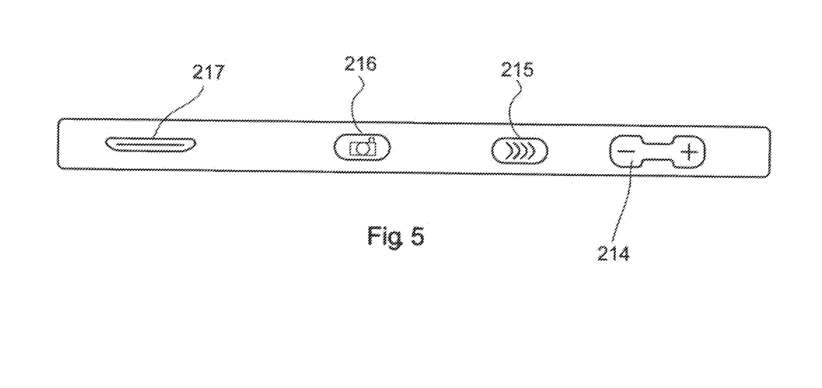

FIG. 2 is an angle view of the embodiment of the device 200 that is disclosed in FIG. 1. FIG. 3 is a top view of the device 200 with the audio port 213 visible from this perspective. The audio port 213 is for connecting devices that permit the user to limit the audio to one. FIG. 4 is the left side view of the device 200 which has external memory port 210 used for adding additional memory. For video quality, the two physical buttons on the top left side are for controlling contrast 211 and sharpness 212. FIG. 5 is the right side view of the device 200. At the top right is the volume 214 used to lower or to increase the audio of the other party. A button located below volume button 214 is the power button 215 for turning on and off the device 200. In the middle is the picture button 216 for capturing an image of a contact party. On the lower right is the power device port 217 for external power source.

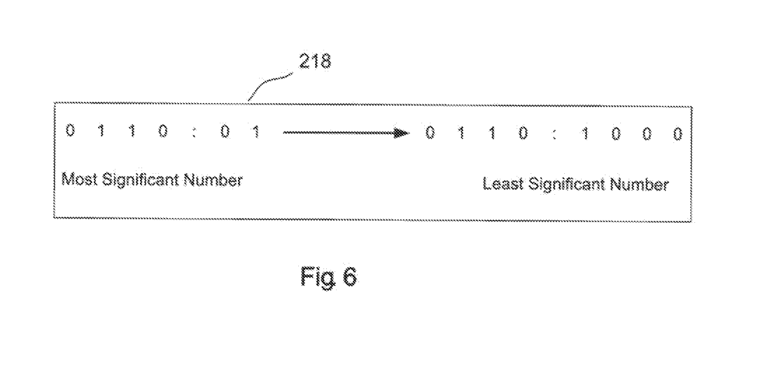

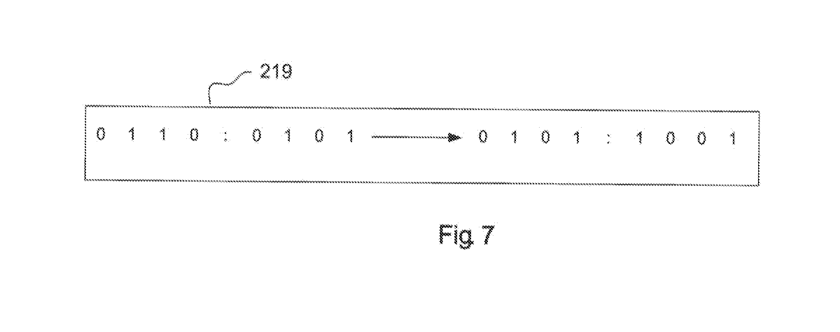

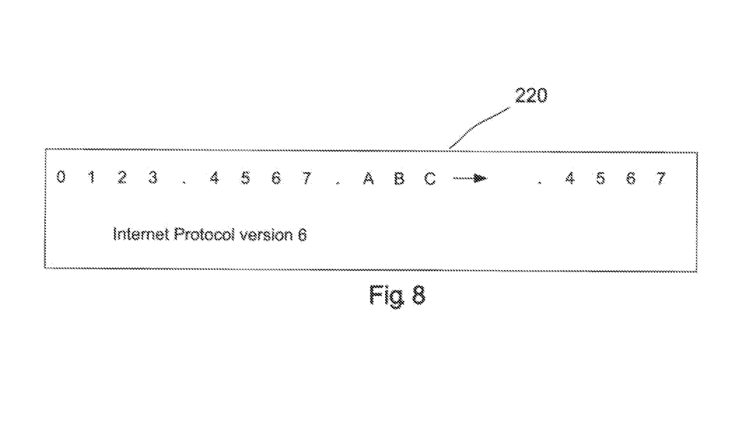

The processes that make the device 200 work with another device is by the use of a sequence of alphanumeric numeration. A cluster of alphanumeric sequence allows two devices 200 to find themselves through the internet. FIG. 6 exemplifies this type of alphanumeric enumeration 218. In FIG. 7 a MAC Address 219 exemplifies this type of encoded alphanumeric enumeration that is used to identify electronic devices. The MAC Address 219 is used to identify the device 200, and the router/modem 233. In order to route a device 200 lookup a device 200 and a modem 233 will seek the other device 200 through the internet 237. A device 200 will look for the other device's ISP IPv6 Address 220 as demonstrated in FIG. 8. Therefore, the first device 200 will look through the internet 237 for the other device's (Device 2) 244 MAC Address 219 and the router/modem's 241 MAC Address.

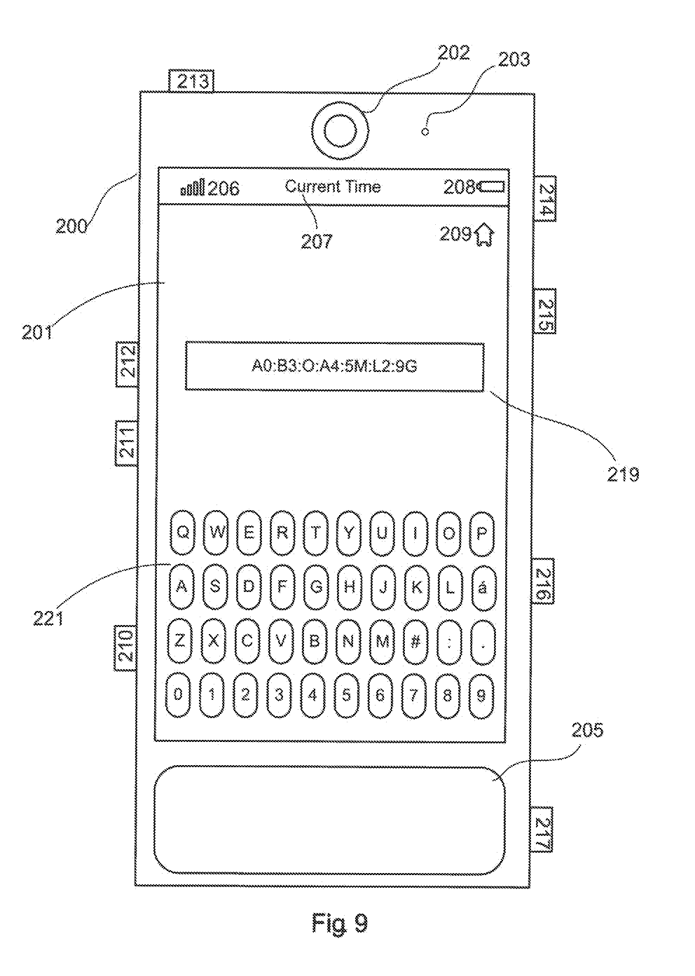

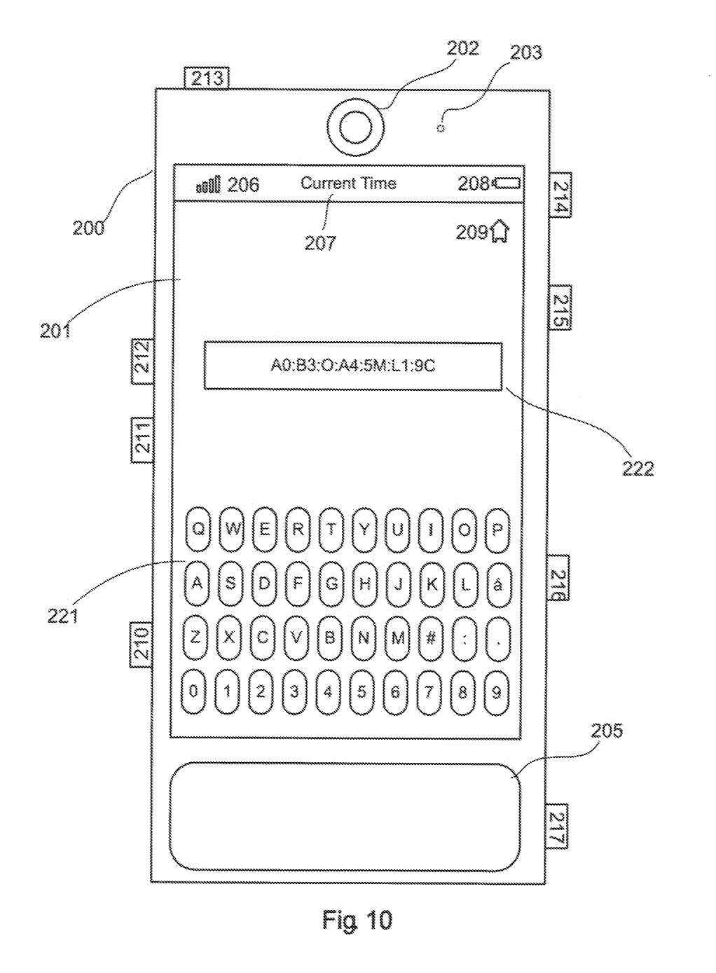

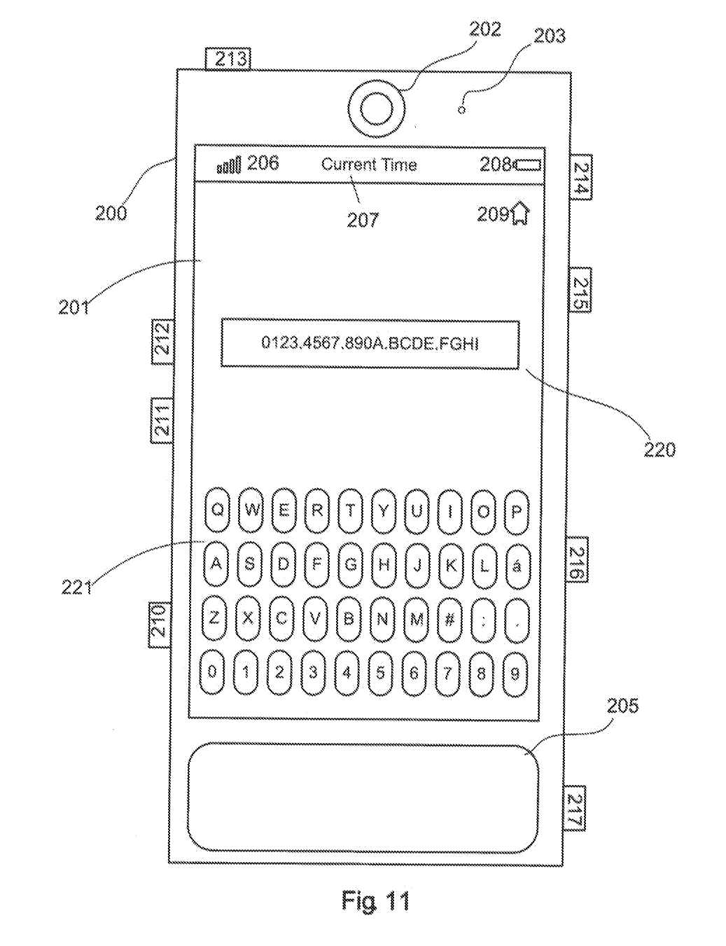

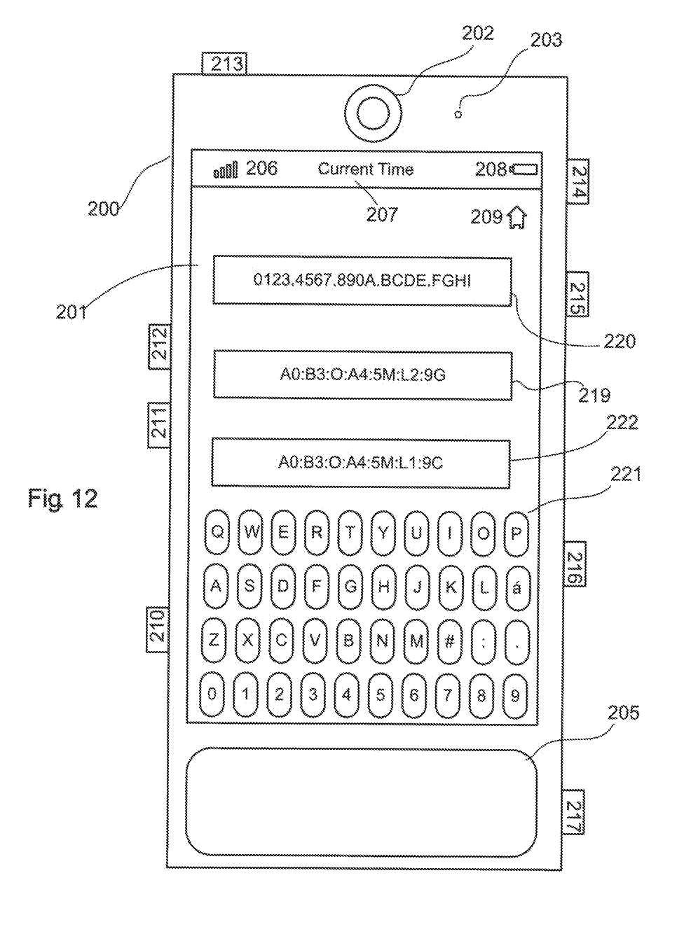

Through the use of several standards that make each device 200 a unique one on the internet, the processes allow two devices find and connect with each other. For example, in FIG. 9 the first user must add the other device's (device 2) 244 MAC Address 219. After adding the MAC Address 219 then as in FIG. 10 the other device's (device 2) router/modem 241 MAC Address 222 is required. A third aggregation is needed in order to expedite a lookup. As shown in FIG. 11, the addition of the IPv6 Address 220 is required. FIG. 12 shows the three consignments including, the other device's MAC Address 219, router/modem MAC Address 222, and IPv6 Address 220. In order to ensure the addition of addresses a QWERTY keyboard 221 is necessary. The qwerty keyboard 221 allows standard EUI-64 and IPv6 protocol. By permitting these standards and protocols, the device 200 is susceptible to receive multicasting, in addition to unicasting.

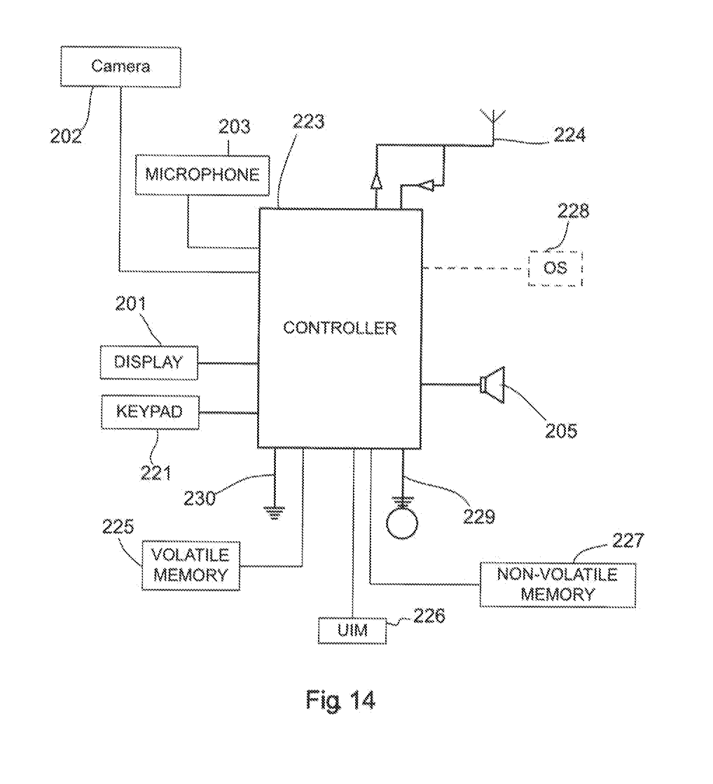

FIG. 14 is a schematic diagram of the subcomponents of the device 200. At the heart of the device 200 is the controller 223, which carries out all operation with the operating system 228. The camera 202 and the microphone 203 are two physical subcomponents that are used in conjunction with the display 201 and the speaker 205. The keyboard 221 along with UIM 226 is used randomly. The volatile memory 225 and the non-volatile memory 227 are used sparingly for regular usage, and for requesting contacts 245. To power the device is either through power connection 230 or through battery power 229. The operating system 228 has few operations in addition to operate the transmit frequency 231 and operate the receive frequency 232 through the antenna 224.

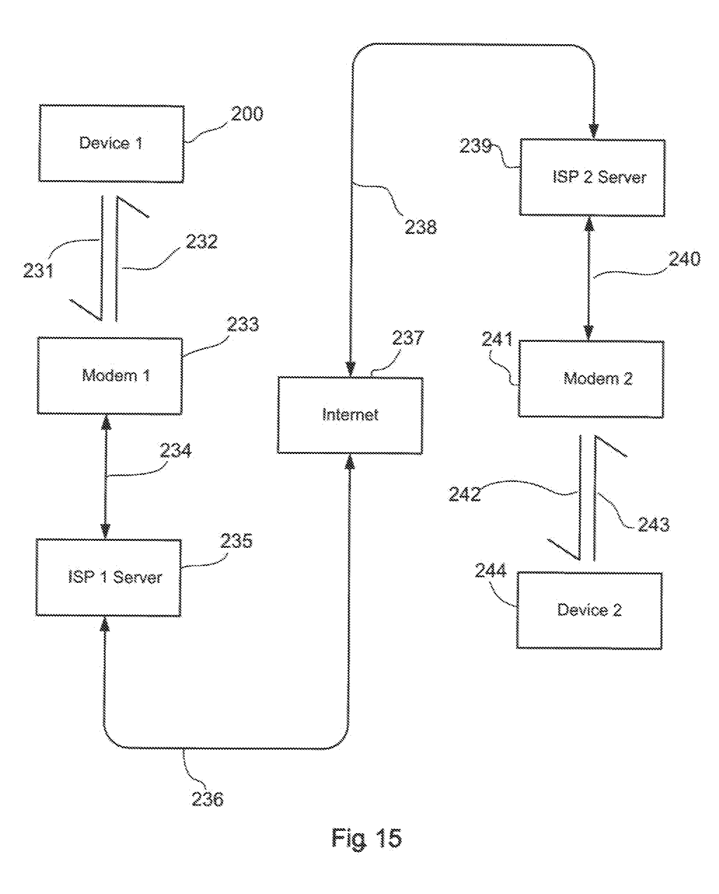

In FIG. 15 a process diagram is depicted whereby device (device 1) 200, once connected to its local router/modem (router/modem 1) 233, sends its transmitting frequency signal 231 and receives the receiving frequency signal 232. The duplex communication is then transceive 234 between the router/modem 233 with its local ISP Server (ISP 1 Server) 235. The ISP 1 Server 235 is connected to the internet 237 via its server to internet line 236. The intercommunication is then reverse as the internet 237 medium 238 is connected back by another ISP Server (ISP 2 Server) 239. The ISP 2 Server 239 thereof is connected to another router/modem (router/modem 2) 241 via its direct line 240. At the receiving end the second device (device 2) 244 already wirelessly connected via its receiving frequency signal 242 and transmitting frequency signal 243.

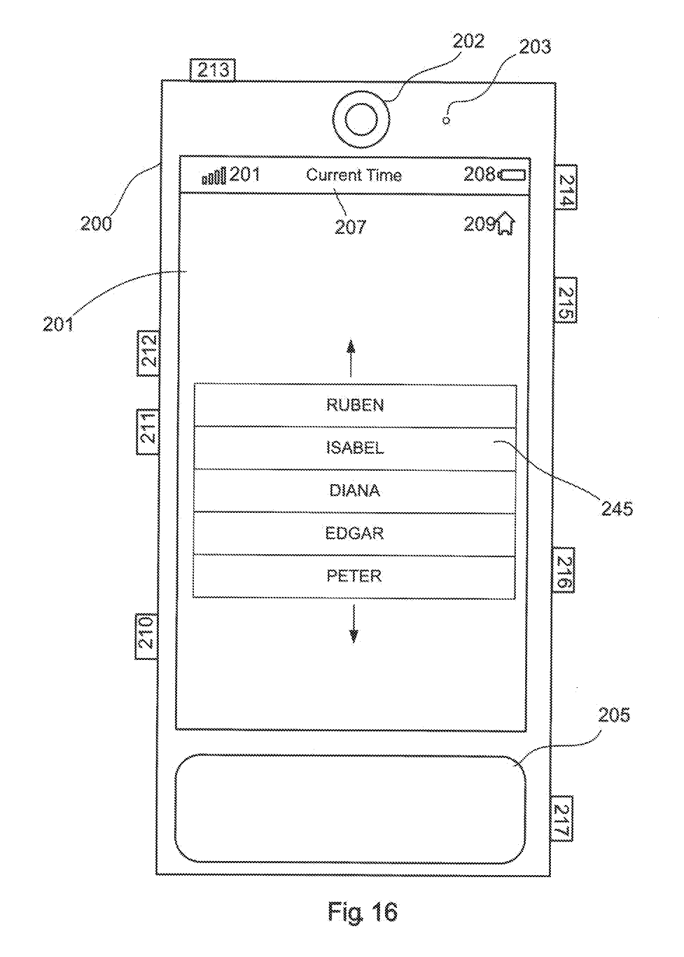

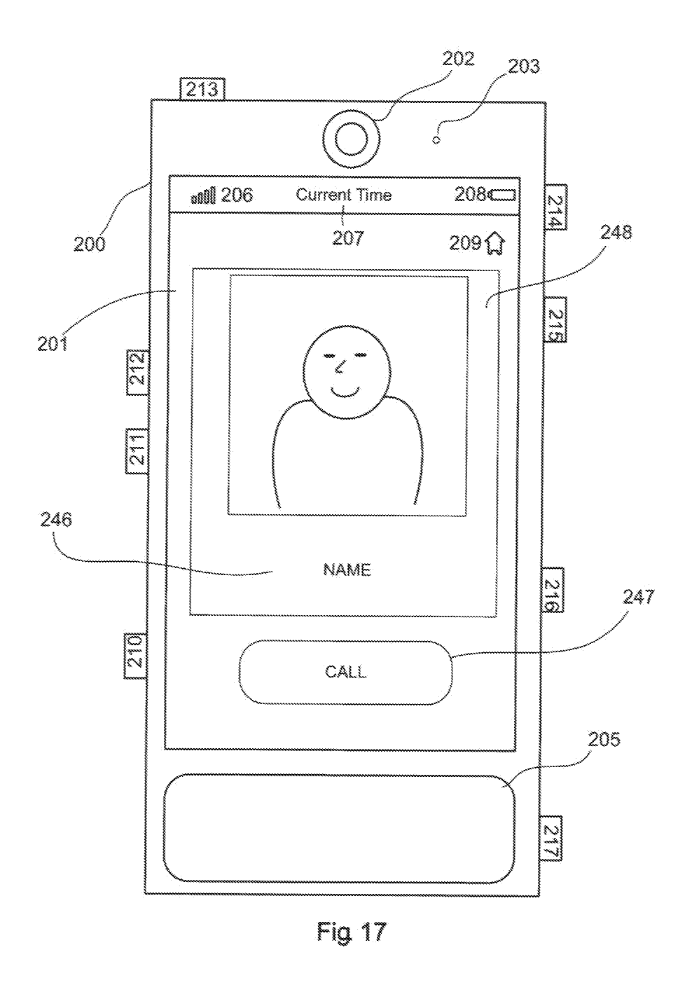

Once all setups are attained a user can just go through the list of contacts 245 as shown is FIG. 16. Once the user determines which contact to call, the user presses the contact 254 on the screen. The contact information is displayed and the picture 248, the name 246 and the call button 247 is displayed as shown in FIG. 17.

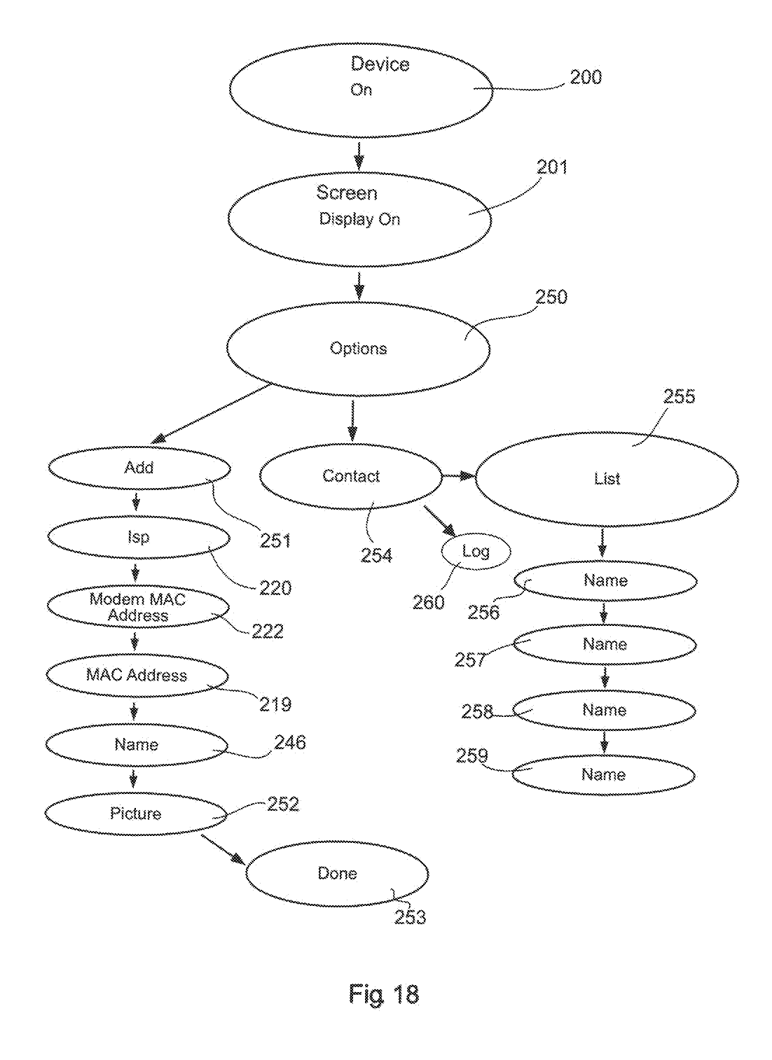

In FIG. 18 the processes for adding contacts is carried out by first turning on the device 200, then the screen display 201 is turned on. Immediately the “options” button 250 is displayed as with the “add” feature 251 and the “contact” button 254. From the “add” button 251 the user can thereby add one addressing scheme (or a sequence of alphanumeric numeration) at a time. First the ISP Server Address 220, then the router/modem MAC Address 222, and the third is the MAC Address 219 for the device 200. Thereafter the user adds the name 246 of the person corresponding to the alphanumeric schemes. The user can then add the contact picture 252, and then press the “done” button 253 to add the contact to the contact list 245. When requesting the contact information from the contact list 245, pressing the contact button 254; two buttons appear; the list 255 and the log 260, which only contains the history. On the list 255 itself, separate names will appear, such as contact-1 256, contact-2 257, contact-3 258, contact-4 259, and so on and so forth. When pressing the “log” button 260 a list of contacts with their corresponding MAC addresses appear apart from other data.

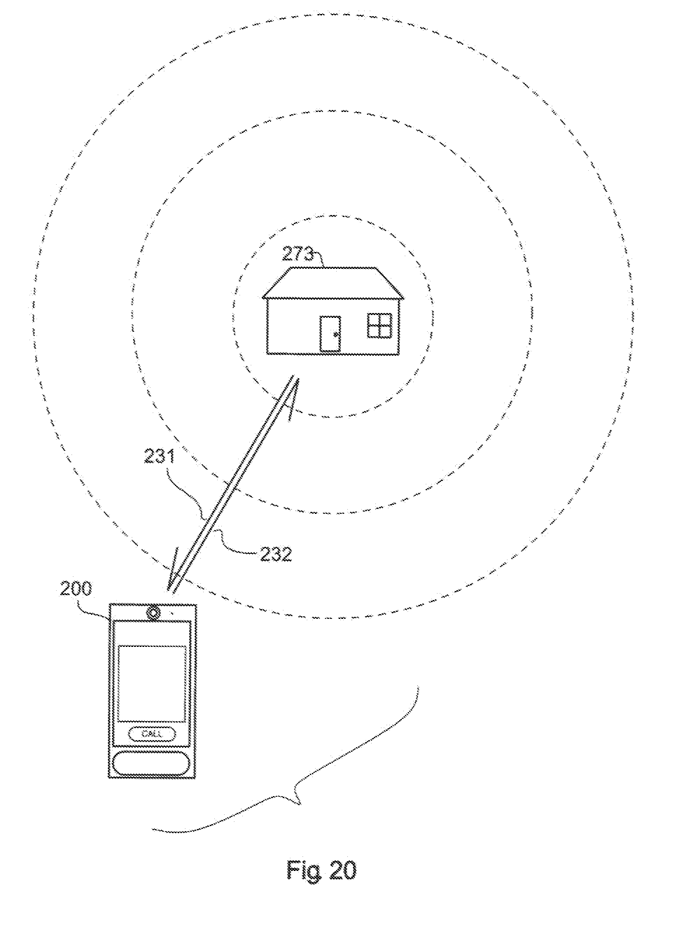

Once a user is familiar in using the device 200 it can be used around the local vicinity of the wireless router/modem 233 as in FIG. 20. As long as wireless line of sight is available the transmitting frequency signal 231 and the receiving frequency signal 232 are not compromised from the assign structure 273, the user can go about communicating with another party.

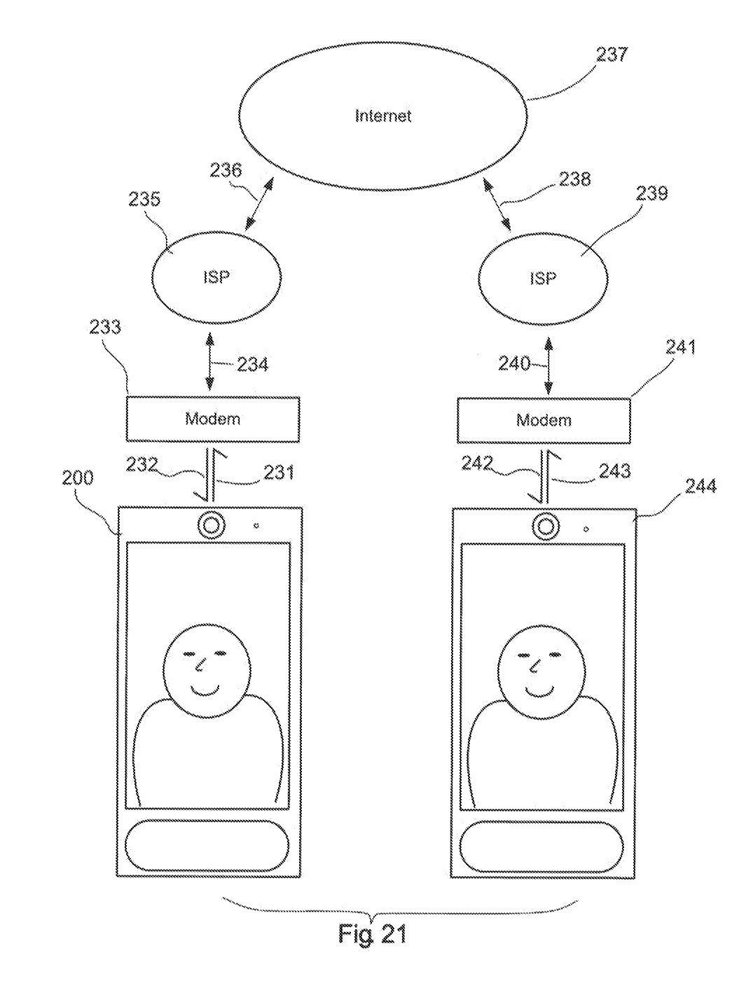

With evolving technologies, communications between two individuals can be carried out as for example in FIG. 21.

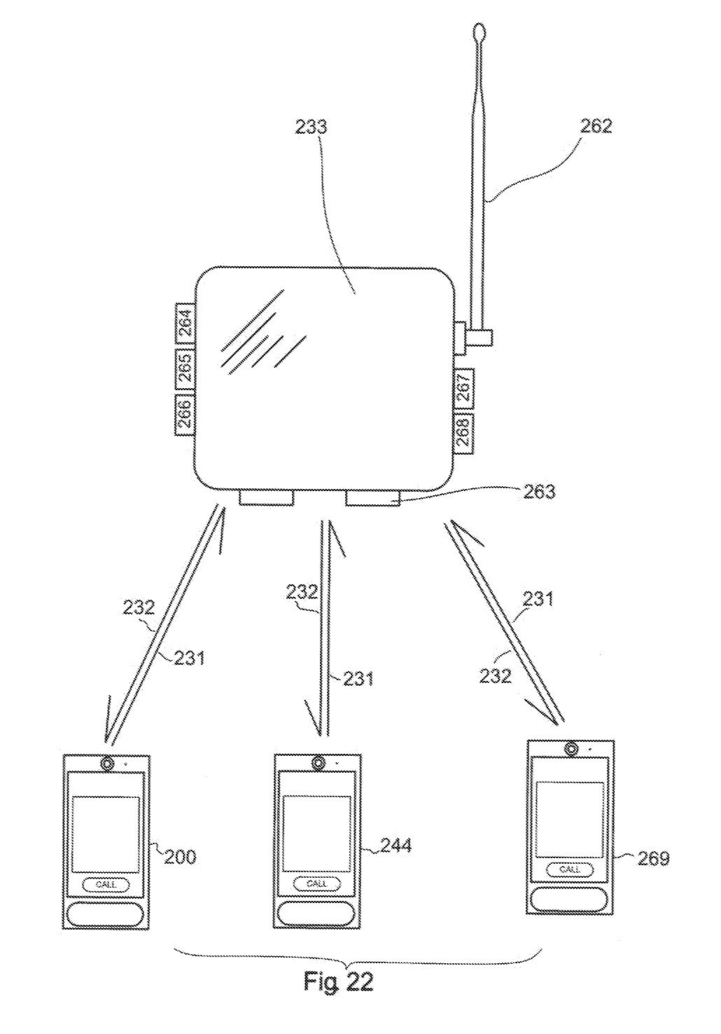

Another technology implementation as in FIG. 22 is the use of multicasting whereby several devices can receive the broadcasting video and audio. In FIG. 22 a typical wireless router/modem 233 with an antenna 262, a power source 268, and a power on button 267, three physical ports, port-1 264, port-2 265, and a third port-266 are able to broadcast a signal to each device 200 individually, or in combination to device 244 and a third device 269. The router/modem leg 263 is for supporting the router/modem 233.

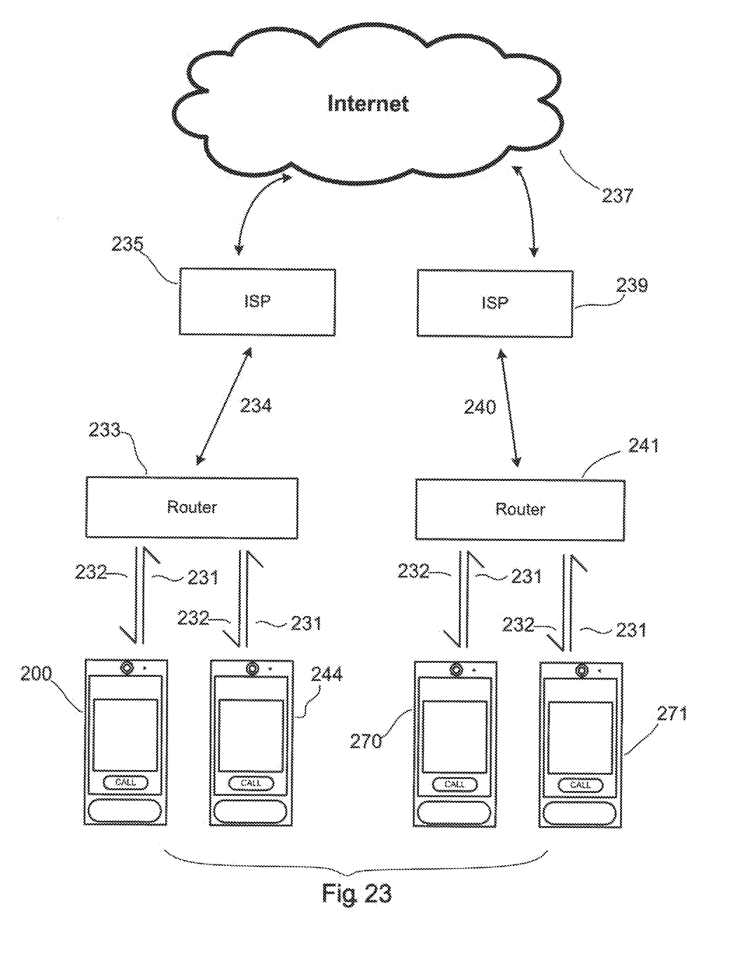

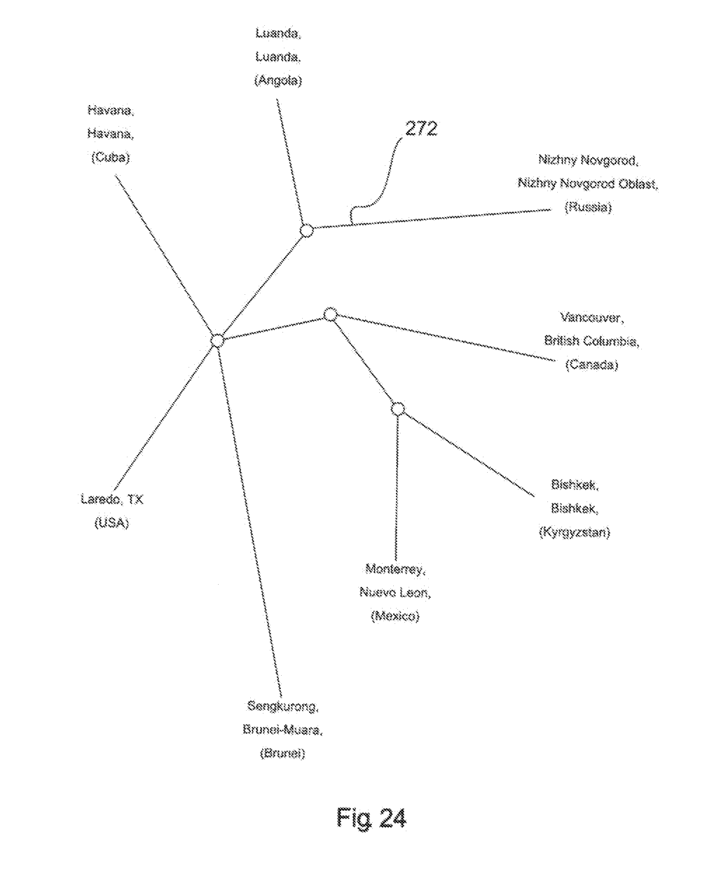

Still another aspect of novel technologies implementation is demonstrated as in FIG. 23. A device 200 can be in contact with another device 244 in the same location, or/and the device 270 and device 271 can be in continuous contact with the two devices. Because of standards such as EUI-64, and IPv6, the chance of interference is infinitesimal when use in combination. Therefore the device 200 can be used to communicate via the World Wide Web 272 as shown in FIG. 24. In FIG. 24 several contacts are available through the World Wide Web 272.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A handheld portable communication device for video and audio live chatting over the internet, the communication device comprising:
a cluster of alphanumeric sequence (or addressing scheme) which allows the device to find and connect with another device of the same type through the internet wherein the cluster of alphanumeric sequence (or addressing scheme) including device MAC address or router/modem MAC address or ISP IPv6 address, or any combination thereof;
a qwerty keyboard;
an operating system;
a controller for carrying out all operation with the operating system;
a volatile memory;
a non-volatile memory;
an antenna;
a display screen;
a camera for receiving an image of a person talking in front of the device;
a microphone for capturing the surrounding sound;
a universal input method (UIM); and
a power supply.

2. The communication device of claim 1, wherein the another device of the same type also comprises a cluster of alphanumeric sequence (or addressing scheme) which including device MAC address or router/modem MAC address or ISP IPv6 address, or any combination thereof.

3. The communication device of claim 2, further comprising a contact list which displays a list of contact names such that a user can press and make a call and a log which shows a list of contacts with their corresponding MAC addresses and history.

4. The communication device of claim 3 further comprising:
a port for connecting an external memory;
an audio port for connecting external hearing devices;
a speaker for audio duplex sound;
a picture button for capturing an image of a contact party;
a device power port for connecting the device to an external power source; and
a home button which is used as an escape key or return key.

5. The communication device of claim 4 further comprising a contrast button and a sharpness button which are used to change the quality of the video display, a volume control button for increasing and decreasing volume, a power button for turning on and off the device.

6. The communication device of claim 5, wherein the screen displays antenna strength, current time, and battery life capacity.

7. The communication device of claim 6, wherein the qwerty keyboard allows standard EUI-64 and IPv6 protocol which enable the device to be susceptible to receive multicasting in addition to unicasting.

8. The communication device of claim 7, wherein the power supply is either battery power or through power connection.

9. The communication device of claim 8, wherein the operating system operates transmitting frequency and receiving frequency through the antenna.

10. A communication method of video and audio live chatting over the internet, the communication method comprising:
providing handheld communication devices each of the devices comprises a cluster of alphanumeric sequence (or addressing scheme) that allows the device to find and connect with another device of the same type through the internet wherein the cluster of alphanumeric sequence (or addressing scheme) including device MAC address or router/modem MAC address or ISP IPv6 address, or any combination thereof;
adding a sequence of alphanumeric numeration corresponding to the second device to a first device's contact list, the sequence of alphanumeric numeration includes the second device's MAC address, router/modem MAC address, and ISP IPv6 address;
connecting the first device with its local router/modem by sending transmitting frequency signal and receiving the receiving frequency signal between the first device and its local router/modem;
transceiving frequency signals between the first device's router/modem and the first device's local ISP server;
connecting the first device's local ISP server to the internet via its server to internet line;
connecting the internet via internet line with a second device's local ISP server which connects with the second device's router/modem via its direct line; and
connecting the second device with its local router/modem by sending transmitting frequency signal and receiving the receiving frequency signal between the second device and its local router/modem.

11. The communication method claim 10, wherein the first and second devices use a cluster of alphanumeric sequence to find each other through the internet, the cluster of alphanumeric sequence include both devices' MAC addresses, or router/modems MAC addresses, or ISP IPv6 addresses or any combination thereof.

12. The communication method of claim 10, wherein the first and second device find each other and connect through the use of the several standards and protocols including EUI-64 and IPv6 protocol that make each device a unique one in the internet.

13. The communication method of claim 10, wherein adding the second device's alphanumeric sequence to the first device's contact list comprising:
pressing an “add” button;
adding one sequence of the alphameric numeration at a time which includes first adding the ISP server address, then the router/modem MAC address, and then the MAC address;
adding a name of the person corresponding to the alphanumeric sequence;
adding a picture of the person corresponding to the alphanumeric sequence; and
pressing a done button to add the contact to the contact list.

14. The communication method of claim 10, wherein a user is able to have a video chat using the device with another user using the same type of device across vast distance around the globe.

15. The communication method of claim 10, wherein multiple users can communicate with each other using the same type of device in one single location.

16. The communication method of claim 10, wherein the device enables multiple users in one single location to communicate with another group of users in another single location.

17. A communication method of video and audio live chatting over the internet, the communication method comprising:
providing an open means of communication for a first device with a similar second device through an internet; and
providing a video and audio communications portal to the first and second devices by interacting with similar addressing schemes;
wherein once the second device is detected a direct communications line is opened between the first and second devices.

18. The communication method of claim 14 further comprising:
providing a typical wireless router/modem with an antenna, a power source, and a button, at least one physical port capable of broadcasting a signal to multiple devices.

19. The communication method of claim 14, wherein the addressing schemes include device MAC address, router/modem MAC address, and IPv6 address which are used to find other similar devices through the internet.

20. The communication method of claim 15, wherein the MAC address is given to the device.
